(19) United States
(12) Patent Application Publication
(10) Pub. No.: US 2011/0175043 A1
(43) Pub. Date: Jul. 21, 2011

(54) High speed winch

(76) Inventor: Kalman N. Lehoczky, Palmetto, FL (US)

(21) Appl. No.: 12/657,440

(22) Filed: Jan. 21, 2010

(51) Int. Cl. B66D 1/44; B66D 1/12

(52) U.S. Cl. 254/277; 254/362

(57) ABSTRACT

Winch for high speed pulling of cable consisting of a winch drum driven by a motor equipped with stator winding for creation of magnetic field with changing rotational direction or stand still and hydraulic damper disk attached to the cable preventing transient oscillations.

### B. BACKGROUND OF THE INVENTION

1. Field of Invention.

This invention relates to winches used to fast pulling and winding up cable with load attached to one end of the cable while the other end of the cable is wound around the drum of the winch and the drum is driven by electric motor with multiphase alternating current winding that creating rotating magnetic field in either rotational direction including stand still and the cable is directly engaged by a hydrodynamic damper disk reducing transient oscillation. Typical application fields are the deep mining, dragging and catapult operations.

2. Description of the Prior Art.

The conventional winching equipment and the problems with the winching operation will be explained using the attached FIG. 3. The equipment consists of the pulled cable 1 with the load 2 on the free end of the cable 1 while the other end of the cable 1 is tied and wound on the winch's drum 3 that is rotated by an motor. When the drum 3 rotates the cable 1 is pulled by the drum 3 and wound up on the surface 16 of the drum 3. During regular low speed pulling operation the cable 1 is exposed to the tensioning force Ft exercised by the load 2 at one end and by the the winch on the other end. Observing a given arch section of the cable 1 being wound on the drum the arch section is under control by a force balance between the opposing tangential force vectors Ft at the ends and the distributed radial reaction force Fd of the drum surface 16. If there is already one or more layers of the cable 1 is wound on the drum 3 the new layers on top of the earlier layers are exercising a radial pressure against the previous layers and indirectly against the drum 3. The drum surface may or may not have circular groves to accommodate the first layer of the wound on cable 1. The groves may have the purpose of reducing the surface pressure between the cable 1 and the drum surface 16 and may also increase the tangential friction force between the cable 1 and the drum surface 3. The cables 1 in the second and following layers may be located axially offset by half width of the cable 1 so that the cables 1 in the outermost cable rest in the channel created between the cables 1 in the previous layer.

During constant low speed pull or lift operation the interaction between cable, drum and motor drive is relatively simple and smooth. The longitudinal tension due to the pull force Ft elongates the cable that is bent over the drum's surface 16.

When the rotation is fast a radially outward oriented centrifugal force Fc attempts to lift the arch section from the drum surface 16 or from the cable layer below. The original low speed radial force Fd between the cable and the drum lessens. Ultimately at very high speed and consequential high centrifugal force Fc the cable 1 may become free flying, the contact force Fd disappears and a gap g appears between the cable 1 and the drum surface 16 or lower layers of cable 1. The drum 3 looses control over the shape of the cable 1 causing waves and random gap g and ultimately destructive contacts and impacts on the surrounding structures.

Variable speed of the cable 1 and drum 3 may introduce additional problems. Acceleration or retardation of the cable 1 would cause that the individual inertias of the load 2, the cable 1, the drum 3 and the driving motor interconnected through elastic members, such as the cable 1, shaft 6 and shaft coupling 7 creates an oscillating dynamic system with several natural frequencies.

A possible dangerous situation would occur if the load 2 at the end of the cable would suddenly disappear. The energy in the tensioned cable 1 would cause the cable 1 to jump forward in a kind of backlash movement and destroy the winch or other objects in the surrounding.

Another critical condition occurs when the regular driving torque from the motor suddenly terminates. This may happen at the end of the pulling operation. The moving load's 2 mass causes the load 2 to continue moving forward even after the slowdown of the drum 3 and may violently collide with the drum 3 or other limiting structures.

An indirect consequence of the longitudinally oscillating cable and changing Ft would cause an incalculable and inconsistent contact between the cable 1 and the drum surface 16. The earlier described static interaction between the cable and the drum surface would become completely invalid. The cable 1 separated from the drum surface 16 would cause violent collisions between the free flying cable 1 and parts of the winch and the nearby structures.

The objective of this invention is to avoid the above disadvantages and short comings by designing a winch system with damping capabilities.

### C. SUMMARY OF INVENTION

Briefly stated, in accordance with one aspect of the present invention winch for pulling a cable with one end of the cable loaded while the other end of the cable is wound around the drum driven by electric motor having stator winding creating magnetic field in either rotational direction including stand still and hydraulic damper disk attached to the cable preventing transient oscillations.

Other features of the invention will be described in connection with the drawings.

### D. DESCRIPTION OF THE DRAWING

FIG. 1 and FIG. 2 shows a winch in two perpendicular projections in accordance with the present invention.

The load 2 is attached to the end of the cable 1 while the other end of the cable 1 is attached to the drum 3 of the winch. The drum is equipped with flanges 4 at both axial ends defining the width of cable layers wound on the drum 3. The drum is mounted on the shaft 6 connected the to the motor's shaft and rotor through a shaft coupling 7 acting as a clutch 7 that can be a disengaged using for example electromagnetic or hydraulic principle. The shaft of the winch and the motor is supported in bearings 8 mounted on the base frame 13. The motor's rotor 11 contains the rotor winding 12 that is a short-circuited “squirrel cage” winding typical for induction motors. The stator 9 surrounding the rotor contains the stator winding 10 that can be a multiphase alternating current winding typical for induction motors. The multiphase winding's connection points 14 is shown in single line representation but in real world consist of several connection points depending on the number of phases and parallel branches.

The torque transferred between the drum and the motor may have transients and may go in both rotational direction. The typical operational condition occurs when the drum 3 is pulling and winding up the cable 1. This mode assumes that the connection points 14 receive electric power for example as three phase AC current. As usual in induction motors the induced current in the rotor winding has a relative low frequency AC current. When the load 2 moves in the opposite direction thus the cable 1 is leaving and winding off the drum 3 it may be required that the load's 2 and the cable's 1 movement would be slowed down thus the motor should act as a brake and the torque should oppose the operational torque's direction. In accordance with this invention the connection point 14 shall receive a different type of current, for example direct current that causes that create a stand still magnetic field causing that the rotor winding would experience relative high frequency short circuit alternating current that consumes energy, creates a braking torque and slows the drum's 3 rotation in either direction.

The squirrel cage type induction motor has an inherent damping capacity in regular operational mode, thus when the connection points 14 are connected to a multiphase alternating current source. However, this damping disappears when the power source is disconnected. In accordance with this invention the change of electrical power supply's character at connection points 14 from the operational mode to a different type, such as direct current shall be activated also for damping of possible transient oscillation of cable 1 and drum 3 when the cable 1 is winding down form drum 3 pulled by the load 2 or at stand still. Since the transient conditions are highly probable at many operational conditions, therefore, the existence of an mechanical energy reservoir is highly recommended. The inertia of the motor's rotor 11 may be insufficient, therefore, a kinetic energy reservoir, a flywheel 5 is added to the rotating system. The flywheel 5 may be added to the rotating system either between or outside of the motor bearings. The Figure shows and arrangement where the flywheel 5 is located inside the motor bearings.

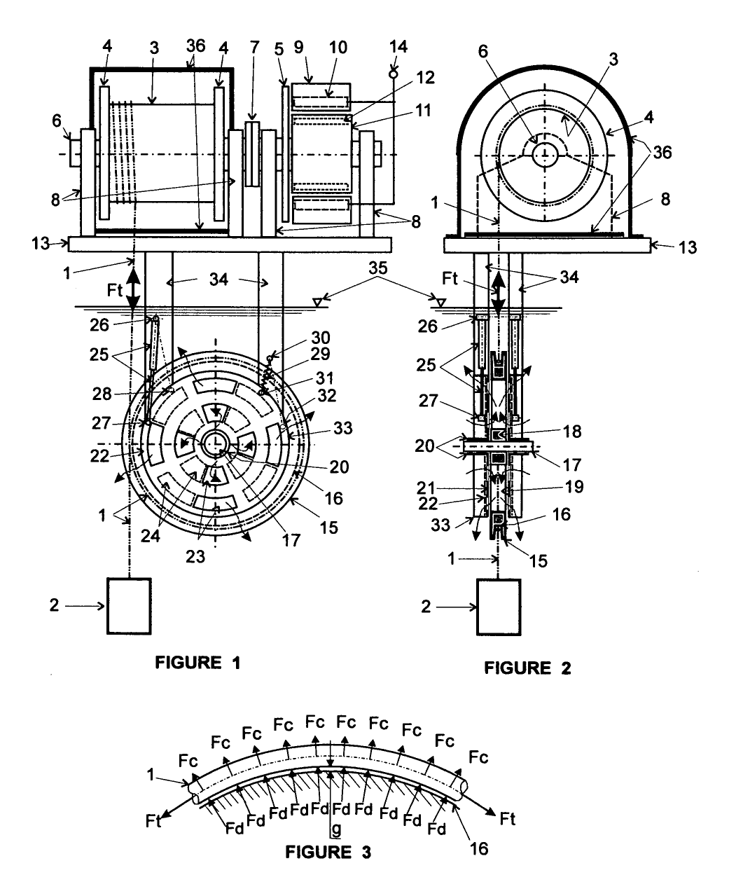

The torque transfer between the motor's rotor and the winch's drum may be an inline direct shaft connection as shown in FIGS. 1 and 2 or through a gear box. Another possibility is to equip the drum's 3 flange 4 with teeth acting as the driven wheel of a gear connection while the motor's shaft is equipped with the driving wheel in the gear connection. The design of the transmission between the motor's rotor 11 and the winch's drum 3 is not limiting for this invention.

There are transient conditions when the cable 1 experiences changing longitudinal tension and possibility of longitudinal and transversal waves may occur. This phenomenon may not involve rotational acceleration or deceleration of the drum 3 and the motor rotor's electrical damping as described before would not be effective. Therefore, in accordance with this invention the cable 1 is engaging a disk 15 that is able to perform rotational movements forced by the cable's 1 longitudinal movements and that the disk 15 is submerged in a fluid for example water. The engagement of the disk 15 by the cable 1 can be ensured by winding the cable 1 around a certain angular section of the disk 15. FIGS. 1 and 2 shows that the disk 15 is equipped with a channel around the circumference where the bottom of the channel is marked 16. The disk with the channel will act like a pulley positioning the cable 1 axially in relation to the disk 15. Off course this interaction between the cable 1 and disk 15 would happen only for a chosen percentage of the disk's 15 circumference.

The fluid surrounding the disk 15 causes that the rotation of the disk is dampened by the hydrodynamic friction between the surrounding fluid and the disk 15 surface. The friction damping progressively increases with the rotational speed, thus the brake or damping torque is very intensive at fast rotation. At even rotational speed a low damping torque is desirable since the damping generate a loss that must be compensated by an increased motor power. From this point of view the disk 15 should have a smooth and simple surface with minimum hydrodynamic rotational resistance. On the other side, a high damping is desirable at transients. In order to satisfy this requirement, in accordance with this invention, the disk is designed with adjustable rotational turning resistance. FIGS. 1 and 2 shows such an arrangement. The disk consists of a shaft 17 with a mounted on hub 18, rotor spider arms 19 that connect the hub 18 with the external periphery also called rim 16. The spider arms 19 should have a shape that imitates the blades of a radial pump creating a pressure increment with the increasing radius starting from the hub 18 to the external diameter of the spider arms 19. During regular operation the flow driven by this pressure difference is minimized by one set of stationary baffle rings 21 and 22, on each side of the spider arms 19. Each baffle ring set consist of an internal baffle ring 21 and an external baffle ring 22. The internal baffle ring 21 is fixed mounted to the circular housing 33 that contains also the bearing 20 and rigidly supported by structures 34 in relation to the winch, for example connected to the base frame 13. The external baffle ring 22 can be rotated inside the housing 33 and concentric with the shaft 17. In accordance with this invention the internal baffle ring 21 is equipped with openings 24 that are hidden behind the external baffle ring during static, non transient movement of the cable 1. The external baffle ring 22 has openings 23 similar to those in the internal baffle ring 21 but these openings 23 are in a different angular location during static non transient conditions, thus no direct axial flow can enter or exit the spider arm 19 area. This situation will be identified as “closed” in the following. The external baffle ring 22 is also located concentric with the shaft 17 but it can be rotated by springs 29 or hydraulic turning mechanisms 25. These devices can turn the external baffle ring 22 so that the openings 23 in the external baffle ring 22 lines up with the openings 24 in the internal baffle ring 21. When this line up occurs, an axial flow can enter the spider arm area close to the hub 18 and exit at larger radius. This situation will be identified as “open”. The spider can start to perform as blades in a radial pump pumping fluid and consuming large amount of energy. This energy loss manifests as a damping torque reducing the disk's 15 rotational oscillation and by this also the interacting cable's 1 longitudinal and transversal oscillation.

In accordance with the FIGS. 1 and 2 one end 30 of the spring 29 is anchored to an unmovable point, for example on the supporting structure 34 while the other end 31 is connected to the external baffle ring 22. During static non-transient operation the spring 29 is tensioned creating a “closed” situation while at transient the spring 29 can be released suddenly turning the external baffle ring into the “open” condition. The detailed design of the release mechanism for the spring 29 and the required automatics is not a limitation for the validity of this invention.

In accordance with the FIGS. 1 and 2 one end 26 of the hydraulic turning mechanism 25 is fixed to an unmovable point, for example to the supporting structure 34 while the other end 27 is connected to the external baffle ring 22. The best use for the hydraulic turning mechanism 25 is a slow rotation of the external baffle ring 22 bringing it into the “closed” position and by this stressing the spring 29. The hydraulic turning mechanism 25 may be disconnected after the closing operation in order to ensure that the springs 29 could perform a fast opening operation without being slowed down by the hydraulic turning mechanism. The detailed design of the hydraulic turning mechanism 25 and the required activating, disengaging mechanisms and their automatics is not a limitation for the validity of this invention.

Considering that the cable 1 during transient events may separate from the drum's 3 surface 16 or from the earlier deposited wound up layers of cable 1 and by creating free flying loops and sections that may damage the surroundings, therefore, in accordance with this invention the winch shall be surrounded by a strong housing 36 able to resist the dynamic impacts and keep the cable 1 inside the winch protecting the surroundings.

The validity of this invention is not limited by location of the hydraulic damper disk 15, thus it may be located on the same or different elevation in relation to the winch and the shaft 17 of the disk 15 may be at any angle between vertical and horizontal. The arrangement shown in FIGS. 1 and 2 is only one of the many location and orientation possibilities. Similarly the type and arrangement of the fluid surrounding the hydrodynamic damper disk 15 for example in oil filled manmade enclosure or naturally existing water containment does not limit the validity of this invention.

What is claimed is:

1. Winch for pulling cable with one end carrying the load and the other end attached to drum driven by an electric motor characterized by the motor having stator winding creating magnetic field rotating in either rotational direction including stand still and the cable is attached to hydrodynamic damper disk reducing transient oscillations.

2. Winch in accordance with claim 1 characterized by a clutch between the motor's rotor and the drum of the winch.

3. Winch in accordance with any of the foregoing claims characterized by the hydrodynamic damper disk having arms radiating from the central hub providing axial and radial open spaces between the arms.

4. Winch in accordance with claim 3 characterized by arms formed as buckets in water turbines.

5. Winch in accordance with any of the foregoing claims characterized by fixed cover plates preventing the surrounding fluid to circulate through the hydraulic damper disk.

6. Winch in accordance with any of the foregoing claims characterized by cover plates with opening adjustable to permit fluid circulation through the hydraulic damper disk.

7. Winch in accordance with claim 6 characterized by hydraulic activator to adjust and activate the cover plate.

8. Winch in accordance with any of the foregoing claims characterized by springs to adjust and activate the cover plate.
